(19) United States
(12) Patent Application Publication
(10) Pub. No.: US 2011/0142977 A1
(43) Pub. Date: Jun. 16, 2011

(54) Extended Life Tire Curing Bladder Composed of Aramid Fibers

(75) Inventor: Ken Lee Phelps, Little Rock, AR (US)

(73) Assignee: Tire Curing Baldders LLC, Littlr Rock, AR (US)

(21) Appl. No.: 13/058,209

(22) PCT Filed: Oct. 20, 2009
(86) PCT No.: PCT/US2009/061265

§ 371 Date: Feb. 9, 2011

Related U.S. Application Data
(60) Provisional application No. 61/120,512, filed on Dec. 8, 2008.

(51) Int. Cl. B29D 30/06; B29C 43/10; B29C 43/36; C08K 3/22; C08L 9/00; C08L 77/10

(52) U.S. Cl. 425/52; 524/432

(57) ABSTRACT

Disclosed is a mixture to create expandable curing bladders for use in the curing process of rubber compositions such as tires. The bladders have an increased service with the addition of the aramid fibers to the rubber polymer. The aramid fibers increase the tear resistance of the cured product allowing for an increased number of expansions and contractions of the rubber polymer during the curing process. The use of these aramid fibers allows the tire curing bladders to cure more tires without changing out the bladder increasing the cost efficiency of the tire curing bladder.

### BACKGROUND OF INVENTION

1. Field of Invention

This invention generally relates to resin cured synthetic polymers, and the process of preparing a desired rubber composition along with the method of using the same for making shapes that are uniquely designed to expand and contract under pressure to form automobile tires inside of a form.

2. Background Art

This invention relates to the composition of a tire curing bladder used to form automobiles tires in a mold. The use of tire curing bladders is well known to people having skill in the art. A tire curing bladder is a device made of an expandable rubber composition that is used inside the mold of a tire. The tire curing bladder is forcibly expanded under pressure and heat from the inside of a tire to force the green rubber into a mold to create different tire treads. The pressure of the fluid or air inside the tire curing bladder is then released allowing the tire to be removed from the mold. The tire curing bladder is then reused for the next tire.

The relative movement of the tire curing bladders consists of expansion under pressure and heat and then contraction as the pressure is released from inside the bladder. This movement of expansion and contraction causes the tire curing bladder to become worn and it must be replaced after several uses. In order to reduce costs of making tires, a tire curing bladder that is composed of a rubber composition that maximizes the number of uses in creating tires would be cost beneficial to the tire manufacturing process.

Accordingly, the tire curing bladder must be composed of a resilient material allowing for expansion and contraction of the bladder composition to maximize the number of times it may be used to create a tire. After several uses the bladder becomes worn and causes defects in the tire. The more times the tire curing bladder can be used in the manufacturing process the lower the cost of creating the tire. This invention embodies a new rubber composition that extends the life of the tire curing bladder.

Previously, U.S. Pat. No. 4,547,544 disclosed a composition of a tire curing bladder that improves the air bleed and release characteristics of the bladder. The '544 patent is directed at the characteristics of the bladder that allow for improved molding by bleeding the excess air between the bladder and the tire. The bladder forces the rubber inside the tire mold into a form and if air pockets exist between the bladder and the rubber then the tire will be formed with defects. The '544 patent also discloses that its composition increases the ability of the bladder to release from the rubber tire inside the mold decreasing defects caused by the bladder sticking to the rubber tire.

The present invention is directed at increasing the life of the tire curing bladder in order to get more uses out of the bladder before it must be replaced and is not directed at air bleeding and release characteristics.

However, U.S. Pat. No. 4,877,469 discloses a composition of tire curing bladder that is provided with reinforcing cords wound in parallel spiral paths around the tire curing bladder. This patent teaches that the cords extend the life of the tire curing bladder.

The present invention utilizes aramid fibers in a random fashion that reinforces the bladder and extends its life. None of the prior art discussed above nor any of the prior discussed in the referenced patents suggest that by adding aramid fibers to the tire curing bladder mix would extend the life of the tire curing bladder.

### BRIEF SUMMARY OF INVENTION

This invention embodies an enhanced composition of rubber and aramid fibers used to create a tire curing bladder that extends the normal life of a tire curing bladder. It is the object of this invention to provide a tire curing bladder composition which increases the service life of the bladder. The mixture of the aramid fibers with the rubber composition increases the number of times the tire curing bladder can expand and contract under heat and pressure during the manufacture of tires. This extended service life of the tire curing bladder decreases the number of times the bladder must be replaced thereby reducing the costs to create tires. This embodiment of the present invention will become apparent from the following detailed description.

### DETAILED DESCRIPTION OF THE INVENTION

The detailed description of this invention will show how to make and use the tire curing bladder. It is well known in the art of making tires that tire curing bladders are used to force under pressure rubber into a mold to create a tire. The rubber compound comprising a mixture of butyl polymer, neoprene with aramid fibers, carbon black, process oil, zinc oxide, and phenolic curing resin. The raw materials are combined together in an internal mixer. During the mixture process, the mixture is heated through the friction of the mixing process.

The compound is made in a two stage process. The first stage has the above materials added in the following order: (1) add the butyl polymer and neoprene integrated with aramid fibers in an industrial mixer, (2) mix this combination for 30 seconds, then (3) add the carbon black, process aid (wax), mix thoroughly, then (4) add the process oil at 270 degrees F., and allow to mix thoroughly, then dump the mix at 350 degrees F. The mixture is now ready for the second stage. The materials used in stage one weighs 380 pounds and this weight is used to determine the amount of materials added in the second stage.

The second stage consists of loading the first stage batch back into the mixer and adding curing resin and zinc oxide into the mixer in 2:1 ratio. This 2:1 ratio of curing resin/zinc oxide is then added to 355 pounds of stage one material. Mix these chemicals at 195-200 degrees F. and the batch is ready for the bladder mold. The curing resin is ground in a fine powder and is mixed with the zinc oxide at a 2:1 curing resin/zinc oxide ratio. The total weight of the curing resin/zinc oxide is twenty five pounds and the total batch weight of stage one plus stage two materials is 380 pounds. The bags are pre-weighed and are added in the banbury in low melt plastic bags.

The first stage is mixed at a high temperature to allow for proper dispersion of the raw materials. The second stage is mixed at a lower temperature to incorporate the curing chemicals, but not hot enough to cause the compound to become scorched. The aramid fibers are supplied in the rubber matrix. The rubber may be either butyl or neoprene. The aramid fibers are added to the first stage mix at the same time the polymer is added to the mixture. This is to allow the fibers to mix and fully disperse in the compound. The aramid fibers improve the tear resistance of the cured product, thereby increasing the life of the curing bladder.

What is claimed is:

1. An extended life rubber composition comprising a mixture of:
a. Butyl polymer
b. Neoprene or butyl rubber with aramid fibers
c. Carbon black
d. Process oil
e. Zinc oxide
f. Phenolic curing resin
Whereby said aramid fibers are mixed and heated in a manner in which a resilient, flexible and strong matrix for tire curing bladder will be provided.

2. An improved tire curing bladder comprises a cylindrical membrane of rubber according to claim 1 wherein the said butyl or neoprene with aramid fibers having random locations within the butyl or neoprene dispersed through the mixing process.

3. An improved tire curing bladder according to claim 1 wherein said neoprene or butyl with aramid fibers comprises Kevlar pieces.

4. Wherein said Kevlar pieces having lengths of 0.01 millimeters to 0.5 millimeters.
